(19) United States
(12) Patent Application Publication
(10) Pub. No.: US 2024/0159951 A1
(43) Pub. Date: May 16, 2024

(54) WIRE GRID POLARIZING ELEMENT, METHOD OF MANUFACTURING WIRE GRID POLARIZING ELEMENT, AND OPTICAL APPARATUS

(71) Applicant: Dexerials Corporation, Shimotsuke-shi (JP)

(72) Inventor: Tomu Takeda, Shimotsuke-shi (JP)

(73) Assignee: Dexerials Corporation, Shimotsuke-shi (JP)

(21) Appl. No.: 18/489,466

(22) Filed: Oct. 18, 2023

(30) Foreign Application Priority Data
Nov. 14, 2022 (JP) 2022-181940

(51) Int. Cl. G02B 5/30; G02B 1/18

(52) U.S. Cl. CPC G02B 5/3058; G02B 1/18

(57) ABSTRACT

A wire grid polarizing element is provided that includes: a transparent substrate; and grid-like projections arranged on one surface of the transparent substrate with a pitch shorter than the wavelength of light in a used band, and extending in a predetermined direction. The transparent substrate is transparent to light in the used band. The grid-like projections each have a reflective layer, the dielectric layer, and an absorption layer, and have a surface on at least a part of which an inorganic structure capable of expressing water repellency exists.

This application is based on and claims the benefit of priority from Japanese Patent Application No. 2022-181940, filed on 14 Nov. 2022, the content of which is incorporated herein by reference.

### BACKGROUND OF THE INVENTION

### Field of the Invention

The present invention relates to a wire grid polarizing element, a method of manufacturing a wire grid polarizing element, and an optical apparatus.

### Related Art

A polarizing element is an optical element that absorbs polarized light in a predetermined direction and transmits polarized light in a direction perpendicular to the predetermined direction. In a liquid crystal display device, a polarizing element is necessary in principle. In particular, in a liquid crystal display device that uses a light source of a large quantity of light such as a transmissive liquid crystal projector, a polarizing element is required to have durability in order to receive intense radiant rays, a size about several centimeters, a high extinction ratio, and is required to be controlled in reflectance characteristics. To meet these requirements, a wire grid polarizing element has been suggested.

The wire grid polarizing element includes a transparent substrate, and grid-like projections arranged on one surface of the transparent substrate with a pitch (such as from equal to or greater than several tens of nanometers to equal to or less than several hundreds of nanometers, for example) shorter than the wavelength of light in a used band, and extending in a predetermined direction. When light is incident on the wire grid polarizing element, it is not possible for s-polarization (TE wave (s wave)) having an electric field component parallel to the extending direction of the grid-like projection to be transmitted through the wire grid polarizing element while p-polarization (TE wave (p wave)) having an electric field component vertical to the extending direction of the grid-like projection is transmitted through the wire grid polarizing element.

Providing a multilayer structure in the wire grid polarizing element makes the wire grid polarizing element controllable in reflectance characteristics. This makes it possible to reduce degradation of image quality due to a ghost, etc. to be caused if feedback light reflected on a surface of the wire grid polarizing element is reflected again in the device. For this reason, the wire grid polarizing element is suitable for a liquid crystal projector.

Meanwhile, light sources for illumination and displays have been developed from lamps to LEDs and then lasers. In a liquid crystal projector, increasing brightness is promoted by using a plurality of semiconductor lasers (LDs). In response to this, improving the durability of the wire grid polarizing element has been desired.

According to Patent Document 1, a water-repellent film is formed using a fluorine-based silane compound such as perfluorodecyltriethoxysilane on surfaces of grid-like projections and on a surface of a bottom portion of a groove defined between the grid-like projections.
Patent Document 1: Japanese Patent No. 6678630

### SUMMARY OF THE INVENTION

However, as the fluorine-based silane compound is used in forming the water-repellent film, performance degradation due to a used environment is unavoidable. In response to this, improving the durability of the wire grid polarizing element while maintaining the optical characteristics thereof has been desired.

The present invention is intended to provide a wire grid polarizing element capable of being improved in durability while maintaining the optical characteristics thereof.

(1) A wire grid polarizing element including: a transparent substrate; and grid-like projections arranged on one surface of the transparent substrate with a pitch shorter than the wavelength of light in a used band, and extending in a predetermined direction, the transparent substrate being transparent to light in the used band, the grid-like projections each having a reflective layer, a dielectric layer, and an absorption layer, and having a surface on at least a part of which an inorganic structure capable of expressing water repellency exists.

(2) The wire grid polarizing element as described in aspect (1), in which the inorganic structure is capable of expressing high water repellency.

(3) The wire grid polarizing element as described in aspect (2), in which the inorganic structure is capable of expressing super water repellency.

(4) The wire grid polarizing element as described in any one of aspects (1) to (3), in which the inorganic structure has a surface on which a concave part and/or a convex part is formed.

(5) The wire grid polarizing element as described in aspect (4), in which the concave part has a semispherical shape, and the convex part has a semispherical shape.

(6) The wire grid polarizing element as described in aspect (5), in which the concave part has a diameter equal to or greater than 2 nm and equal to or less than 4 nm and a depth equal to or greater than 2 nm and equal to or less than 4 nm, and the convex part has a diameter equal to or greater than 2 nm and equal to or less than 4 nm and a height equal to or greater than 2 nm and equal to or less than 4 nm.

(7) The wire grid polarizing element as described in aspect (4), in which the convex part has a shape of one or more types selected from a group consisting of a fractal shape, a pillar shape, a whisker shape, and a tetrapod shape.

(8) A method of manufacturing a wire grid polarizing element including: forming a stacked body on one surface of a transparent substrate by stacking a reflective layer, a dielectric layer, and an absorption layer; and forming grid-like projections arranged with a pitch shorter than the wavelength of light in a used band and extending in a predetermined direction by etching the stacked body selectively, the grid-like projections each having a surface on at least a part of which an inorganic structure capable of expressing water repellency exists.

(9) An optical apparatus including the wire grid polarizing element as described in any one of aspects (1) to (7).

According to the present invention, it is possible to provide a wire grid polarizing element capable of being improved in durability while maintaining the optical characteristics thereof.

### BRIEF DESCRIPTION OF THE DRAWINGS

FIG. 1 is a schematic perspective view showing an example of a wire grid polarizing element according to the present embodiment;

FIG. 2 is a schematic sectional view showing the wire grid polarizing element in FIG. 1;

FIGS. 3A and 3B are schematic sectional views each showing an example of an inorganic structure existing on a surface of a grid-like projection in FIG. 1;

FIGS. 4A to 4D are schematic sectional views each showing another example of the inorganic structure existing on the surface of the grid-like projection in FIG. 1;

FIG. 5 is a schematic sectional view showing a modification of the wire grid polarizing element in FIG. 1;

FIG. 6 is a schematic sectional view showing a wire grid polarizing element used in simulation;

FIGS. 7A and 7B are graphs showing respective transmittances of p-polarization and s-polarization through the wire grid polarizing element in FIG. 6; and

FIGS. 8A and 8B are graphs showing respective reflectances of the p-polarization and the s-polarization on the wire grid polarizing element in FIG. 6.

### DETAILED DESCRIPTION OF THE INVENTION

An embodiment of the present invention will be described below by referring to the drawings.

### [Wire Grid Polarizing Element]

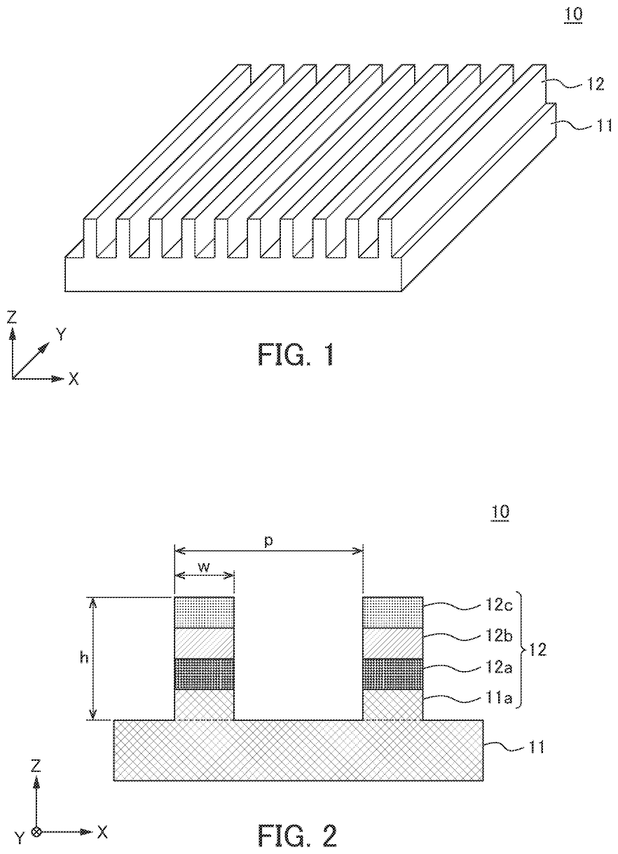

FIGS. 1 and 2 show an example of a wire grid polarizing element according to the present embodiment.

A wire grid polarizing element 10 includes a transparent substrate 11, and grid-like projections 12 arranged on one surface of the transparent substrate 11 with a pitch p shorter than the wavelength of light in a used band, extending in a Y-axis direction, and having a width w and a height h.

As shown in FIGS. 1 and 2, the direction in which the grid-like projections 12 extend is called the Y-axis direction. A direction perpendicular to the Y-axis direction and in which the grid-like projections 12 are arranged with the pitch p along a principal plane of the transparent substrate 11 is called an X-axis direction. Furthermore, a direction perpendicular to the Y-axis direction and the X-axis direction and vertical to the principal plane of the transparent substrate 11 is called a Z-axis direction. While light to be incident on the wire grid polarizing element 10 may be incident from either side of the transparent substrate 11, the light is preferably incident in the Z-axis direction from a side of the transparent substrate 11 on which the grid-like projections 12 are arranged.

The wire grid polarizing element 10 utilizes four actions of selective light absorption of polarization including transmission, reflection, interference, and optical anisotropy, thereby attenuating s-polarization (TE wave (s wave)) having an electric field component parallel to the Y-axis direction and transmitting p-polarization (TE wave (p wave)) having an electric field component parallel to the X-axis direction. Thus, in FIGS. 1 and 2, the Y-axis direction corresponds to a direction of an absorption axis of the wire grid polarizing element 10 and the X-axis direction corresponds to a direction of a transmission axis of the wire grid polarizing element 10.

As shown in FIG. 2, the grid-like projections 12 each have a base 11a formed on the transparent substrate 11, a reflective layer 12a, a dielectric layer 12b, and an absorption layer 12c arranged in this order as viewed from the transparent substrate 11. The grid-like projections 12 have a wire grid configuration arranged in a one-dimensional grid pattern on the one surface of the transparent substrate 11.

As long as the grid-like projection has the reflective layer, the dielectric layer, and the absorption layer, it may have a layer other than these layers, as needed, or may not have the base 11a. The order in which the reflective layer, the dielectric layer, and the absorption layer are formed is not particularly limited.

An inorganic structure capable of expressing water repellency exists on at least a part of a surface of the grid-like projection 12. The inorganic structure may exist only on a top surface of the grid-like projection 12 or may exist on at least a part of a side surface of the grid-like projection 12 in addition to the top surface of the grid-like projection 12. By doing so, the durability of the wire grid polarizing element 10 is improved while the optical characteristics thereof are maintained. Moreover, as a water-repellent film is not required to be formed using a fluorine-based silane compound, influence on global environment is reduced.

While the inorganic structure is capable of expressing water repellency, it preferably expresses high water repellency, more preferably, expresses super water repellency.

In the present specification and the claims, water repellency means that an angle of contact with water is equal to or greater than 90°, high water repellency means that an angle of contact with water is equal to or greater than 110° and less than 150°, and super water repellency means that an angle of contact with water is equal to or greater than 150°. As an example, an angle of contact θ_{f} of a composite surface made of a material 1 and a material 2 with water is expressed by the Cassie formula:

cos θ_{f}=A₁ cos θ₁+A₂ cos θ₂

(in the formula, θ₁ and θ₂ show respective angles of contact of the material 1 and the material 2 with water, A₁ and A₂ show respective area ratios of the material 1 and the material 2, and A₁+A₂=1.)

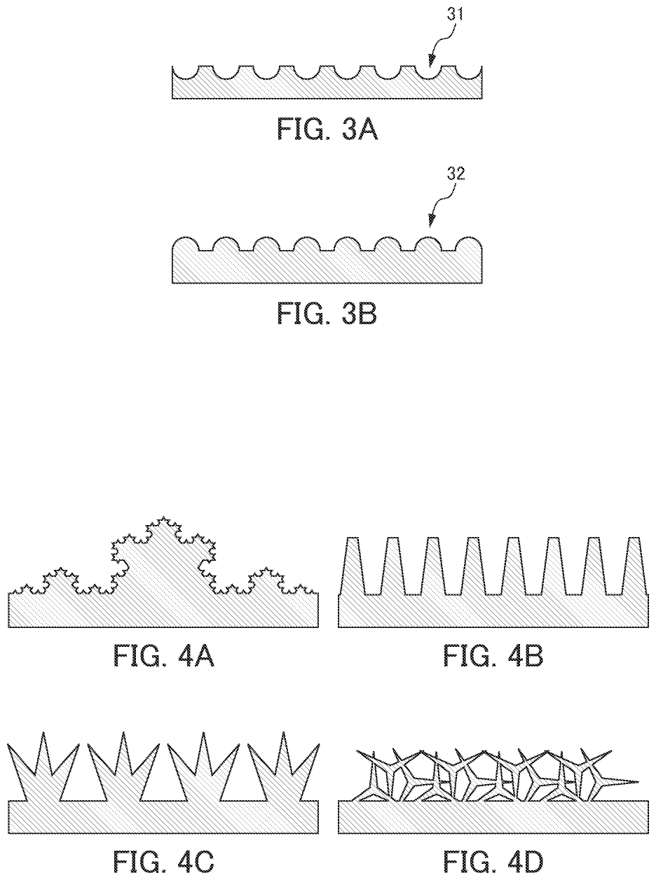

The inorganic structure has a concave part 31 (see FIG. 3A) and/or a convex part 32 (see FIG. 3B) formed on a surface of the inorganic structure. Here, the inorganic structure is preferably made of the same material as a material forming the layer on the grid-like projection 12. As long as the optical characteristics of the wire grid polarizing element 10 are maintained, the inorganic structure may be made of a different material from the material forming the layer on the grid-like projection 12.

Preferably, the concave part 31 has a diameter equal to or greater than 2 nm and equal to or less than 4 nm, and a depth equal to or greater than 2 nm and equal to or less than 4 nm. With the diameter and the depth of the concave part 31 equal to or greater than 2 nm, the inorganic structure expresses super water repellency easily. With the diameter and the depth of the concave part 31 equal to or less than 4 nm, the optical characteristics of the wire grid polarizing element 10 are maintained easily.

Preferably, the convex part 32 has a diameter equal to or greater than 2 nm and equal to or less than 4 nm, and a height equal to or greater than 2 nm and equal to or less than 4 nm. With the diameter and the height of the convex part 32 equal to or greater than 2 nm, the inorganic structure expresses super water repellency easily. With the diameter and the height of the convex part 32 equal to or less than 4 nm, the optical characteristics of the wire grid polarizing element 10 are maintained easily.

The inorganic structure with the concave part 31 formed on the surface thereof is formed by depositing an inorganic material with inorganic nano particles placed on the surface, and then etching the inorganic nano particles selectively, for example. The inorganic structure with the convex part 32 formed on the surface thereof is formed by depositing an inorganic material with inorganic nano particles placed on the surface, and then etching the inorganic material selectively as necessary, for example. In forming the inorganic structure with the concave part 31 or the convex part 32 formed on the surface thereof, instead of depositing the inorganic material with the inorganic nano particles placed on the surface, an inorganic material containing inorganic nano particles may be deposited.

While the concave part 31 and the convex part 32 have semispherical shapes, the shapes thereof are not particularly limited. For example, the convex part 32 may have a fractal shape (see FIG. 4A), a pillar shape (see FIG. 4B), a whisker shape (see FIG. 4C), or a tetrapod shape (see FIG. 4D). In another case, the shape of each of the concave part 31 and the convex part 32 may be defined by mixing a plurality of shapes.

The inorganic structure with the convex part having the pillar shape or the whisker shape provided on the surface thereof is formed by precipitation from an inorganic material or by abnormal growth through plasma treatment or thermal treatment on a surface of the inorganic material, for example. The inorganic structure with the convex part having the tetrapod shape provided on the surface thereof is formed by depositing a needle-like crystalline body on the surface and then depositing an inorganic material, for example.

Light incident from the side of the transparent substrate 11 on which the grid-like projections 12 are arranged is partially absorbed to be attenuated in passing through the absorption layer 12c and the dielectric layer 12b. P-polarization (TE wave (p wave)) being part of the light having been transmitted through the absorption layer 12c and the dielectric layer 12b is transmitted through the reflective layer 12a with high transmittance. On the other hand, s-polarization (TE wave (s wave)) being part of the light having been transmitted through the absorption layer 12c and the dielectric layer 12b is reflected on the reflective layer 12a. While the s-polarization having been reflected on the reflective layer 12a is partially absorbed in passing through the dielectric layer 12b and the absorption layer 12c, it is partially reflected to return to the reflective layer 12a. The s-polarization having been reflected on the reflective layer 12a causes interference in passing through the dielectric layer 12b and the absorption layer 12c to be attenuated. In this way, the s-polarization is selectively attenuated to allow the wire grid polarizing element 10 to have desired polarization characteristics.

Here, the height h means a size in the Z-axis direction vertical to the principal plane of the transparent substrate 11. The width w means a size in the X-axis direction perpendicular to the height h when the wire grid polarizing element 10 is viewed from the Y-axis direction. Furthermore, the pitch p is a repetition interval of the grid-like projections 12 in the X-axis direction when the wire grid polarizing element 10 is viewed from the Y-axis direction.

As long as the pitch p is shorter than the wavelength of light in a used band, it is not particularly limited. Meanwhile, from the viewpoint of easiness of forming the wire grid polarizing element 10 and the stability of the wire grid polarizing element 10, the pitch p is preferably equal to or greater than 100 nm and equal to or less than 200 nm, for example. The pitch p can be measured through observation under a scanning electron microscope or a transmissive electron microscope. As an example, the pitches p at any four positions may be measured using the scanning electron microscope or the transmissive electron microscope and an arithmetic average of the measured values may be defined as the pitch p. In the following, this measuring method will be called electron microscopy.

### (Transparent Substrate)

As long as a material forming the transparent substrate 11 is transparent to light in a used band, it is not particularly limited but an appropriate material can be selected according to purpose.

In the present specification and the claims, “being transparent to light in a used band” does not mean that the light in the used band has transmittance of 100% but it means that this light has transmittance allowing retention of a function as a polarizing element. As an example, the light in the used band is light such as visible light having a wavelength about equal to or greater than 380 nm and about equal to or less than 810 nm.

A material used for forming the transparent substrate 11 can be a material having a refractive index equal to or greater than 1.1 and equal to or less than 2.2 such as glass, rock crystal, quartz, or sapphire, for example. Of these materials, quartz and glass are preferred from the viewpoint of cost and light transmittance. Quartz (with a refractive index of 1.46) and soda-lime glass (with a refractive index of 1.51) are particularly preferred. Furthermore, from the viewpoint of thermal conductivity, rock crystal and sapphire are preferred. By doing so, the durability of the transparent substrate 11 is improved to provide applicability as a polarizing element for an optical engine of a projector to generate a large amount of heat.

If crystal having optical activity such as rock crystal or sapphire is used as the material forming the transparent substrate 11, it is preferable that the grid-like projections 12 or grid-like projections 52 be arranged in a direction parallel to or vertical to an optical axis of the crystal. By doing so, excellent optical characteristics are obtained. Here, the optical axis means a directional axis that makes a difference in refractive index between O (ordinary ray) and E (extraordinary ray) of light traveling in a direction of the optical axis minimum.

While the thickness of the transparent substrate 11 is not particularly limited, it is equal to or greater than 0.1 mm and equal to or less than 3 mm, for example. While a method of measuring the thickness of the transparent substrate 11 is not particularly limited, electron microscopy is employed, for example.

At this time, the transparent substrate 11 to be used may be prepared by bonding a plurality of substrates to each other into a unified substrate. Furthermore, while the shape of the principal plane of the transparent substrate 11 is not particularly limited, it may be a rectangular shape, for example. The transparent substrate 11 may be a flexible substrate.

The base 11a is formed by etching the transparent substrate 11, for example.

### (Reflective Layer)

The reflective layers 12a are arranged on the one surface of the transparent substrate 11 with the pitch p and extend in the Y-axis direction. The reflective layer 12a has a function as a polarizer. The reflective layer 12a attenuates s-polarization (TE wave (s wave)) having an electric field component in a direction parallel to the extending direction of the reflective layer 12a and transmits p-polarization (TM wave (p wave)) having an electric field component in a direction perpendicular to the extending direction of the reflective layer 12a.

As long as a material forming the reflective layer 12a is a material that causes reflection of light in a used band, it is not particularly limited. Examples of such materials include metals such as Al, Ag, Cu, Mo, Cr, Ti, Ni, W, Fe, Si, Ge, Te, and Nd, and alloys containing one or more types of these metals. Of these materials, Al or an Al alloy is preferred.

The reflective layer 12a may be an inorganic film or a resin film other than a metal film given high surface reflectance by a colorant, for example.

While the thickness of the reflective layer 12a is not particularly limited, it is equal to or greater than 100 nm and equal to or less than 300 nm, for example. While a method of measuring the thickness of the reflective layer 12a is not particularly limited, electron microscopy is employed, for example.

While process of forming the reflective layer 12a is not particularly limited, vapor deposition process or sputtering process is employed, for example.

The reflective layer 12a may be a stacked body with two or more layers made of different materials.

### (Dielectric Layer)

The dielectric layers 12b are formed on the reflective layers 12a. Specifically, the dielectric layers 12b are arranged with the pitch p and extend in the Y-axis direction.

The thickness of the dielectric layer 12b is set within a range in which the phase of s-polarization transmitted through the absorption layer 12c and reflected on the reflective layer 12a is shifted a half wavelength from the s-polarization reflected on the absorption layer 12c. More specifically, while the thickness of the dielectric layer 12b is not particularly limited as long as it can enhance interference effect by adjusting the phase of the s-polarization, this thickness is properly adjusted within a range from equal to or greater than 1 nm to equal to or less than 1500 nm, for example. While a method of measuring the thickness of the dielectric layer 12b is not particularly limited, electron microscopy is employed, for example.

A material forming the dielectric layer 12b is not particularly limited. Examples of this material include an Si oxide, a Ti oxide, a Zr oxide, an Al oxide, an Nb oxide, a Ta oxide, and an Hf oxide.

The refractive index of the dielectric layer 12b is preferably equal to or greater than 1.0 and equal to or less than 2.5. The optical characteristics of the reflective layer 12a are influenced by the refractive index of the dielectric layer 12b. Thus, selecting the material forming the dielectric layer 12b makes it possible to control the optical characteristics of the wire grid polarizing element 10. Furthermore, by adjusting the thickness and the refractive index of the dielectric layer 12b properly, when s-polarization is transmitted through the absorption layer 12c after being reflected on the reflective layer 12a, part of this s-polarization can be reflected and can return to the reflective layer 12a. This allows the s-polarization having passed through the absorption layer 12c to be attenuated through interference. By attenuating the s-polarization selectively in this way, it becomes possible to obtain desired polarization characteristics.

While process of forming the dielectric layer 12b is not particularly limited, vapor deposition process, sputtering process, chemical vapor deposition (CVD) process, or atomic layer deposition (ALD) process is employed, for example.

The dielectric layer 12b may be a stacked body with two or more layers made of different materials.

### (Absorption Layer)

The absorption layers 12c are formed on the dielectric layers 12b. Specifically, the absorption layers 12c are arranged with the pitch p and extend in the Y-axis direction.

While the thickness of the absorption layer 12c is not particularly limited, it is equal to or greater than 5 nm and equal to or less than 50 nm, for example. While a method of measuring the thickness of the absorption layer 12c is not particularly limited, electron microscopy is employed, for example.

As long as a material forming the absorption layer 12c is a material that absorbs light in a used band, specifically, a material having an extinction coefficient that is not zero, it is not particularly limited. This material may be metal, an alloy, or semiconductor, for example. Examples of the metal include Ta, Al, Ag, Cu, Au, Mo, Cr, Ti, W, Ni, Fe, and Sn. Examples of the alloy include alloys containing one or more types of these metals. Examples of the semiconductor include Si, Ge, Te, ZnO, and silicide materials (β-FeSi₂, MgSi₂, NiSi₂, BaSi₂, CrSi₂, CoSi₂, and TaSi). As a result, it is possible for the wire grid polarizing element 10 to have a high extinction ratio in a visible light range. Of these materials, the absorption layer 12c preferably contains Fe or Ta, and Si.

The bandgap energy of a semiconductor is involved in light absorption. Hence, if semiconductor is used as a material forming the absorption layer 12c, the bandgap energy of the semiconductor is required to be equal to or less than the energy of light in a used band. If the used band is a visible light range, for example, it is necessary to use a semiconductor that absorbs light having a wavelength equal to or greater than 400 nm, specifically, that has bandgap energy equal to or less than 3.1 eV.

While a process of forming the absorption layer 12c is not particularly limited, vapor deposition process or sputtering process is employed, for example.

The absorption layer 12c may be a stacked body with two or more layers made of different materials.

### (Antireflective Layer)

The wire grid polarizing element 10 may further include an antireflective layer formed on the other surface of the transparent substrate 11.

The antireflective layer is a multilayer film with two or more layers formed on the transparent substrate 11 and made of a material similar to the material forming the dielectric layer 12b. For example, by forming the antireflective layer by alternately stacking a low refractive index layer and a high refractive index layer having different refractive indexes, it becomes possible to attenuate interfacially reflected light through interference.

While the thickness of the antireflective layer is not particularly limited, it is equal to or greater than 1 nm and equal to or less than 50 nm, for example. While a method of measuring the thickness of the antireflective layer is not particularly limited, electron microscopy is employed, for example.

The antireflective layer can be formed as a high-density film by a method similar to that of forming the dielectric layer 12b. Meanwhile, from the viewpoint of the density of the antireflective layer, ion-beam assisted deposition (LAD) process assisted by ion beams or ion beam sputtering (IBS) process is desirably used as process of forming the antireflective layer.

### (Protective Film)

The surface of the wire grid polarizing element 10 may be covered at least partially with a protective film. In this case, an inorganic structure capable of expressing super water repellency may exist on at least a part of the surface of the protective film. super water repellency may also be expressed by covering at least a part of a surface of the inorganic structure with the protective film. Here, a material forming the protective film is the same as the material forming the dielectric layer 12b. By doing so, the durability of the wire grid polarizing element 10 is improved.

The protective film is formed by a process similar to that of forming the dielectric layer 12b or the antireflective layer.

Like the dielectric layer 12b, the protective film can be a stacked body with two or more layers made of different materials.

### (Method of Manufacturing Wire Grid Polarizing Element)

A method of manufacturing the wire grid polarizing element 10 includes: forming a stacked body on one surface of the transparent substrate 11 by stacking a reflective layer, a dielectric layer, and an absorption layer in this order as viewed from the transparent substrate 11; and forming the grid-like projection 12 having a surface on at least a part of which an inorganic structure capable of expressing water repellency exists by etching the stacked body selectively. At this time, the grid-like projection 12 may be formed by selectively etching a stacked body including a layer having a surface on at least a part of which an inorganic structure exists. The grid-like projection 12 may also be formed by selectively etching a stacked body having a surface without an inorganic structure to form a precursor to a grid-like projection, and then forming a layer with an inorganic structure on at least a part of a surface of the precursor to the grid-like projection.

In etching the stacked body selectively, a one-dimensional grid-like mask pattern is formed first on the stacked body using a resist and employing photolithography process or nanoimprint process, for example. Next, a region in the stacked body without the mask pattern is etched.

While a process of the etching is not particularly limited, dry etching process using an etching gas to react with an etching target is employed, for example.

The method of manufacturing the wire grid polarizing element 10 may further include forming an antireflective layer on the other surface of the transparent substrate 11. The method of manufacturing the wire grid polarizing element 10 may further include covering at least a part of a surface of the wire grid polarizing element 10 with a protective film.

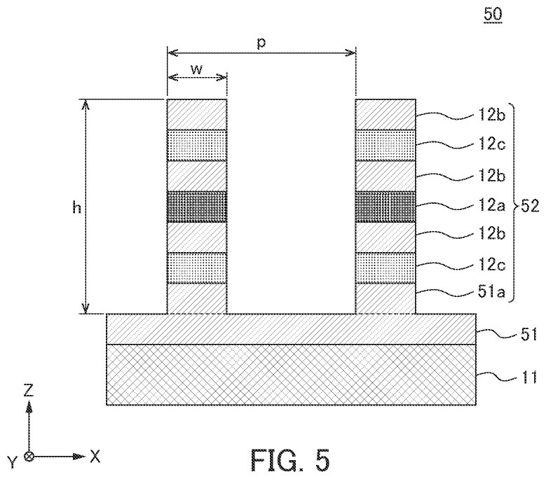

FIG. 5 shows a modification of the wire grid polarizing element 10.

A wire grid polarizing element 50 is similar to the wire grid polarizing element 10, except that the wire grid polarizing element 50 includes a foundation layer 51 formed on one surface of the transparent substrate 11 and includes a grid-like projection 52. Here, the grid-like projection 52 has a base 51a formed on the foundation layer 51, the absorption layer 12c, the dielectric layer 12b, the reflective layer 12a, the dielectric layer 12b, the absorption layer 12c, and the dielectric layer 12b arranged in this order as viewed from the transparent substrate 11. Here, the dielectric layer 12b forming a top surface of the grid-like projection 52 functions as a protective film. The wire grid polarizing element 50 can obtain polarization characteristics of light incident from a side without the grid-like projection 52 comparable to those of light incident from a side with the grid-like projection 52.

### (Foundation Layer)

A material forming the foundation layer 51 is the same as that forming the dielectric layer 12b. This improves adhesion with the absorption layer 12c.

The foundation layer 51 is formed by process similar to that of forming the dielectric layer 12b, the antireflective layer, or the protective film.

Like the dielectric layer 12b, the foundation layer 51 may be a stacked body with two or more layers made of different materials.

The base 51a is formed by etching the foundation layer 51, for example.

### (Simulation)

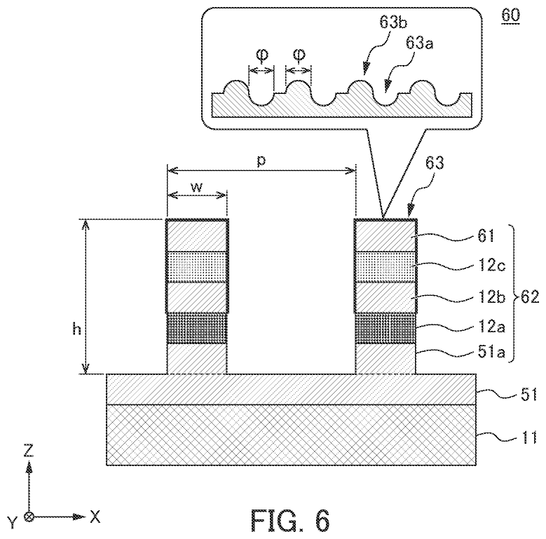

A Simulation was conducted to verify that the optical characteristics of a wire grid polarizing element 60 (see FIG. 6) are maintained even in the presence of an inorganic structure 63. Here, the transparent substrate 11 is a transparent glass substrate EAGLE XG (available from Corning Incorporated), the foundation layer 51 is an SiO₂ film having a thickness of 85 nm, and the base 51a has a thickness of 20 nm. The reflective layer 12a is an Al film having a thickness of 270 nm, the dielectric layer 12b is an SiO₂ film having a thickness of 5 nm, the absorption layer 12c is an FeSi film having a thickness of 25 nm, and a protective film 61 is an SiO₂ film having a thickness of 15 nm. Grid-like projections 62 each have a width (w) of 35 nm, a height (h) of 335 nm, and are arranged with a pitch (p) of 141 nm. The inorganic structure 63 exists on a top surface and a side surface of the protective film 61, on a side surface of the absorption layer 12c, and a on a side surface of the dielectric layer 12b. A concave part 63a formed on a surface of the inorganic structure 63 has a semispherical shape, a diameter of φ [nm], and a depth of φ [nm]. A convex part 63b formed on a surface of the inorganic structure 63 has a semispherical shape, a diameter of φ [nm], and a depth of φ [nm]. Here, the concave part 63a and the convex part 63b are formed adjacent to each other and an interval between the adjacent concave part 63a and convex part 63b is from 0.3 to 1.5 nm.

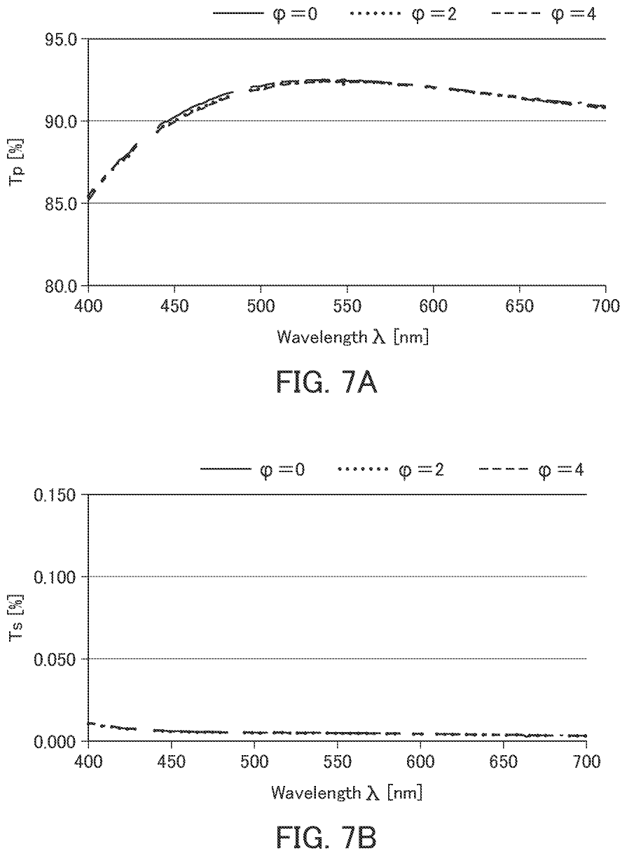

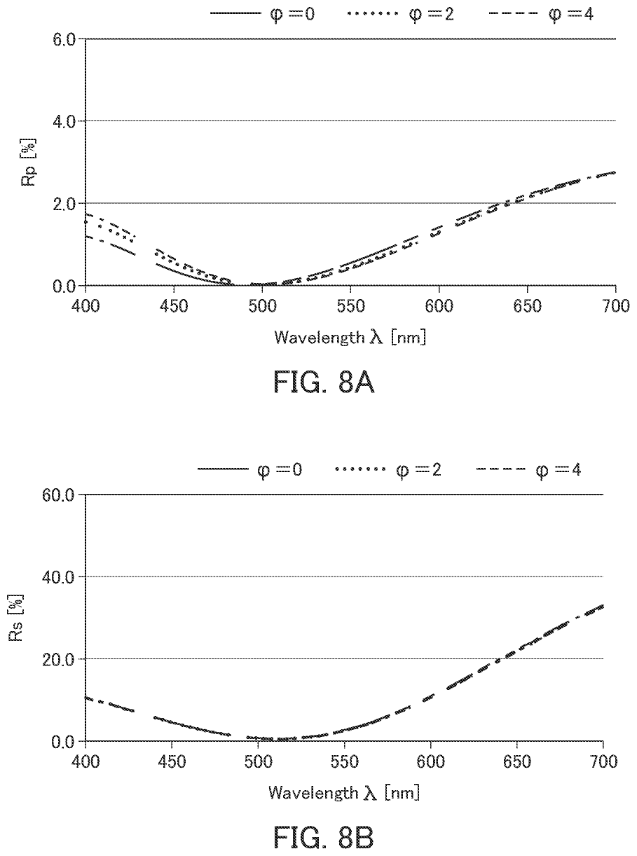

FIGS. 7A and 7B show respective transmittances of p-polarization and s-polarization (Tp and Ts) through the wire grid polarizing element 60. FIGS. 8A and 8B show respective reflectances of the p-polarization and the s-polarization (Rp and Rs) on the wire grid polarizing element 60. Here, φ=0 means that the inorganic structure 63 (concave part 63a and convex part 63b) does not exist on the surface of the grid-like projection 62.

As understood from FIGS. 7A, 7B, 8A, and 8B, even if the inorganic structure 63 (concave part 63a and convex part 63b; φ=2, 4) exists on a top surface of the protective film 61, the optical characteristics of the wire grid polarizing element 60 (respective transmittance characteristics of p-polarization and s-polarization and respective reflectance characteristics of p-polarization and s-polarization) are still maintained.

### [Optical Apparatus]

An optical apparatus of the present embodiment includes the wire grid polarizing element of the present embodiment.

The optical apparatus of the present embodiment is not particularly limited. Examples of the optical apparatus include a liquid crystal display, a display unit such as a signage, a liquid crystal projector, a projection unit such as space rendering lighting, a head-up display, a vehicle-mounted unit such as a headlight, a head-mount display, virtual reality (VR) and augmented reality (AR) units such as smart glasses, and various types of optical sensors. Of these units, a liquid crystal projector is preferred in consideration of the durability of the wire grid polarizing element of the present embodiment.

If the optical apparatus of the present embodiment includes a plurality of polarizing elements, it is sufficient that at least one of these polarizing elements be the wire grid polarizing element of the present embodiment. If the optical apparatus of the present embodiment is a liquid crystal projector, for example, it is sufficient that at least one of a polarizing element arranged on an incident side and a polarizing element arranged on an exit side of a liquid crystal panel be the wire grid polarizing element of the present embodiment.

While the embodiment of the present invention has been described above, the present invention is not limited to the above-described embodiment but the above-described embodiment may be changed, as appropriate, within a range of the purport of the present invention.

### EXPLANATION OF REFERENCE NUMERALS

10, 50, 60 Wire grid polarizing element
11 Transparent substrate
11a Base
12, 52, 62 Grid-like projection
12a Reflective layer
12b Dielectric layer
12c Absorption layer
31, 63a Concave part
32, 63b Convex part
51 Foundation layer
61 Protective film
63 Inorganic structure

What is claimed is:

1. A wire grid polarizing element comprising: a transparent substrate; and
grid-like projections arranged on one surface of the transparent substrate with a pitch shorter than the wavelength of light in a used band, and extending in a predetermined direction,
the transparent substrate being transparent to light in the used band, and
the grid-like projections each having a reflective layer, a dielectric layer, and an absorption layer, and having a surface on at least a part of which an inorganic structure capable of expressing water repellency exists.

2. The wire grid polarizing element according to claim 1, wherein the inorganic structure is capable of expressing high water repellency.

3. The wire grid polarizing element according to claim 2, wherein the inorganic structure is capable of expressing super water repellency.

4. The wire grid polarizing element according to claim 1, wherein the inorganic structure has a surface on which a concave part and/or a convex part is formed.

5. The wire grid polarizing element according to claim 4, wherein the concave part has a semispherical shape, and
the convex part has a semispherical shape.

6. The wire grid polarizing element according to claim 5, wherein the concave part has a diameter equal to or greater than 2 nm and equal to or less than 4 nm and a depth equal to or greater than 2 nm and equal to or less than 4 nm, and
the convex part has a diameter equal to or greater than 2 nm and equal to or less than 4 nm and a height equal to or greater than 2 nm and equal to or less than 4 nm.

7. The wire grid polarizing element according to claim 4, wherein the convex part has a shape of one or more types selected from a group consisting of a fractal shape, a pillar shape, a whisker shape, and a tetrapod shape.

8. A method of manufacturing a wire grid polarizing element comprising: forming a stacked body on one surface of a transparent substrate by stacking a reflective layer, a dielectric layer, and an absorption layer; and
forming grid-like projections arranged with a pitch shorter than the wavelength of light in a used band and extending in a predetermined direction by etching the stacked body selectively, wherein
the grid-like projections each have a surface on at least a part of which an inorganic structure capable of expressing water repellency exists.

9. An optical apparatus comprising the wire grid polarizing element according to claim 1.
